(19) United States
(12) Patent Application Publication
(10) Pub. No.: US 2023/0329219 A1
(43) Pub. Date: Oct. 19, 2023

(54) System and Methods for Mitigation of Dangerous Wildlife

(71) Applicant: Keertana Ramars Jillella Venkata, Wake Forest, NC (US)

(72) Inventor: Keertana Ramars Jillella Venkata, Wake Forest, NC (US)

(21) Appl. No.: 18/133,783

(22) Filed: Apr. 12, 2023

Related U.S. Application Data
(60) Provisional application No. 63/331,812, filed on Apr. 16, 2022.

(51) Int. Cl. A01M 7/00; A01M 29/16; A01M 29/12

(52) U.S. Cl. CPC A01M 7/0089; A01M 29/16; A01M 29/12

(57) ABSTRACT

A device, system and methods are provided which enable images to be captured by an image capturing device. A processor may execute an algorithm to identify any dangerous wildlife present in the captured images. Based on identifying dangerous wildlife, the processor circuit may enable a repellent intervention including a spray of water, audible alarm, olfactory agent, seismic signal or other interventions. The processor circuit may communicate information based on the identified animal to a user via a mobile device or other communication device.

### PRIORITY

This application claims priority to U.S. Provisional Patent Application 63/331,812, filed Apr. 16, 2022, the contents of which are incorporated herein in their entirety.

### FIELD OF THE INVENTION

The present disclosure relates to a system for mitigating dangerous wildlife, more specifically to a system for detection of and response to dangerous wildlife.

### BACKGROUND OF THE INVENTION

As human populations grow and expand into more and more animal habitats, confrontations between humans and animals continue to increase. Dangerous animals such as snakes, bobcats, mountain lions and bears can cause injury and death.

Frequently, mitigation is simply the killing of animals when they have a dangerous interaction with a human. But as populations expand, this is not a sustainable solution to continue killing animals as they have more and more interactions with humans.

Additionally, in certain phyla and classes, only certain species are in fact dangerous. As one example, snakes are members of phylum Chordata, and most members of phylum Chordata are harmless to humans. However, certain species, including rattlesnakes, vipers, coral snakes, among others, are extremely dangerous and in some cases fatal to humans.

The World Health Organization (WHO) estimates that over 125,000 people are killed every year by snake bites, so the threat from some species is real, even though the majority are harmless.

There is a need for a solution which can mitigate dangerous interactions between humans and animals and that is both more humane to the animals, and which can differentiate between harmless animals and potentially dangerous animals.

### SUMMARY OF THE INVENTION

According to one aspect, a device includes an image capture device, a processor circuit to receive input from an activation signal and to receive images from the image capture device, the processor to identify features in the received images based on images stored in a database, the processor to generate an identification result, a repellent to be enabled based at least upon the identification result, and a transceiver to transmit information from the processor circuit to a mobile communication device, the information based at least on the identification result, and to receive information from the from a mobile communication device, the information based upon the effectiveness of the repellent.

According to one aspect, a system includes a vehicle, an image capture device, a processor circuit to receive input from an activation signal and to receive images from the image capture device, the processor to identify features in the received images based on images stored in a database, the processor to generate an identification result, a repellent to be enabled based at least upon the identification result, and a transceiver to transmit information from the processor circuit to a mobile communication device, the information based at least on the identification result, and receive information from the from a mobile communication device, the information based upon the effectiveness of the repellent.

A method comprising generating an activation signal, activating a processor circuit based upon the activation signal, capturing one or more images, transmitting the captured images to the processor circuit, identifying a species of animal in the captured images to generate an identification result, repelling the animal based on the identification result, and transmitting information based upon the identified species of animal.

### BRIEF DESCRIPTION OF THE DRAWINGS

FIG. 1 illustrates one of various examples of a system for mitigating dangerous wildlife.

FIG. 2 illustrates one of various examples of a mobile system for mitigating dangerous wildlife.

FIG. 3 illustrates one of various methods for mitigating dangerous wildlife.

### DETAILED DESCRIPTION

The following description includes specific details to provide an understanding of a wildlife mitigation system. Embodiments of the wildlife mitigation system described in the following description may be incorporated into other devices not disclosed in the following description. Structures and elements shown in the drawings are exemplary embodiments of the wildlife mitigation system and are not to be used to limit broader teachings of the wildlife mitigation system.

It is understood through the text of this disclosure that where elements are described as separate functional units, those skilled in the art will recognize that various elements or portions thereof may be integrated together. Where elements are described in the following description as integrated together into a combined element, those skilled in the art will similarly recognize that individual elements of the combination may be utilized as separate elements.

This specification includes references to “an embodiment of the wildlife mitigation system” or “one embodiment of the wildlife mitigation system”. This language is intended to refer to the particular elements and structures of the embodiment being discussed in that portion of the specification. Where references are made to “an embodiment of the wildlife mitigation system” or “one embodiment of the wildlife mitigation system” in other portions of the specification, those similarly refer to those particular elements and structures of the embodiment being discussed in that portion of the specification. Embodiments discussed in different portions of the specification may or may not refer to the same embodiment of the wildlife mitigation system.

The use of specific terminology in the specification is used for best describing the wildlife mitigation system and shall not be construed as limiting. The terms “include”, “including”, “comprise” and “comprising” shall be understood to be open terminology and not limiting the listed items.

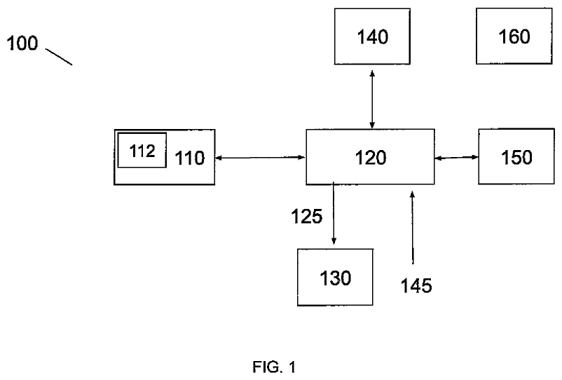

FIG. 1 shows one of various examples of a system 100 for mitigating dangerous wildlife. An image capture device 110 may capture images of an outdoor or indoor scene. Image capture device 110 may capture images from an underwater scene.

Image capture device 110 may be a camera capable to capture light in the visible spectrum between 400 nanometers and 700 nanometers of wavelength. Image capture device 110 may be a camera capable to capture light in the infrared spectrum between 700 nanometers and 1000 nanometers of wavelength. Image capture device 110 may be a camera capable to capture light from a spectrum outside both the visible spectrum and the infrared spectrum. Capturing light from a spectrum outside the visible spectrum may enable detection of warm-blooded animals during low-light conditions and during the night.

Image capture device 110 may be a radar transmitter and radar sensor to transmit radar waves and sense reflected radar waves to detect warm-blooded and cold-blooded animals during day or night. Image capture device 110 may be a sonar transmitter and sensor to transmit sonar waves and sense reflected sonar waves to detect warm-blooded and cold-blooded animals in bodies of water.

Image capture device 110 may be a thermal imaging camera to identify warm-blooded animals by sensing heat.

Image capture device 110 may be a Light Detection and Ranging (LIDAR) transmitter and sensor system capable to transmit laser light and to sense reflected laser light to detect cold-blooded and warm-blooded animals, in both night and day.

A motor 112 may rotate or move image capture device 110 to capture multiple images in a wide angle. Motor 112 may enable image capture device 110 to capture multiple images in a 360-degree view. Motor 112 may enable image capture device 110 to move through a set of segments of three-dimensional space to track an animal.

Image capture device 110 may be coupled to processor circuit 120. Processor circuit 120 may control image capture device 110 to move through a set of segments of three-dimensional space to track an animal. Image capture device 110 may be activated by a signal from processor circuit 120. Processor circuit 120 may receive an activation signal 145 from a user via a mobile app or remote control device. Processor circuit 120 may receive an activation signal 145 from an external device, including but not limited to a motion sensor or a timer. Processor circuit 120 may be a single hardware embodiment, or may be one or more processor circuits in a larger device. Processor circuit 120 may be comprised of a central processing unit (CPU) and one or more memory devices. Processor circuit 120 may include one or more bus interfaces to communicate with other devices. Processor circuit 120 may include other peripheral devices not shown in FIG. 1.

Processor circuit 120 may receive images from image capture device 110. Processor circuit 120 may process images received from image capture device 110 according to an identification algorithm. The identification algorithm may identify one or more features in the received images. The identification algorithm may identify one or more dangerous reptiles or animals in the received images. The identification algorithm may be a software program executing within processor circuit 120 or may be a dedicated hardware circuit within processor circuit 120.

During execution of the identification algorithm, processor circuit 120 may access information in database 150. Database 150 may include images of dangerous animals. Captured images may be compared against images in database 150. Images in database 150 may include captured images, synthetic images, or a combination of captured images and synthetic images. Database 150 may include additional information on specific animal species, including but not limited to images, descriptions of behavior, common predators, and preferred repellent interventions. Information accessed in database 150 may be used by the identification algorithm. Processor circuit 120 may produce an output 125 based upon the identification algorithm. Output 125 may be a single enable signal, or output 125 may be one or more encoded signals for communicating additional information based on the identification algorithm, the additional information including but not limited to coordinates indicative of the location of the dangerous wildlife, a positional angle of the repellent 130, a speed or a temperature for repellent 130. The additional information may include but is not limited to a wavelength, amplitude, frequency and time period for an audible sound alarm, and a pressure for a liquid or gaseous repellent.

Output 125 may be provided to repellent 130. Repellent 130 may include one or more interventions for repelling wildlife, including but not limited to a stream of water or other liquid, an audible alarm, dispersal of an olfactory agent, or generation of a seismic signal. The olfactory agent may be a chemical or biological compound with a predetermined smell.

Processor circuit 120 may communicate with transceiver 140. Processor circuit 120 may send instructions to transceiver 140 to instruct transceiver 140 to send information from the identification algorithm to a remote device.

Power supply 160 may provide power to components in system 100. Power supply 160 may provide power to image capture device 110, motor 112, processor circuit 120, repellent 130 and database 150. Individual connections between power supply 160 and individual components are not shown to improve readability of the figure. Power supply 160 may include a rechargeable battery. Power supply 160 may include one or more solar panels to charge a rechargeable battery. Power supply 160 may include a wired connection to an alternating-current or direct-current power source. Power supply 160 may include a liquid hydrogen energy source.

In operation, in one of various examples, a user may send activation signal 145 to processor circuit 120. Activation signal 145 may be sent via a mobile communication device over a communication network, or activation signal 145 may be sent via a physical switch or button over a wired connection. Upon receipt of the activation signal 145, processor circuit 120 may communicate with image capture device 110 and initiate capture of one or more images by image capture device 110. Processor circuit 120 may communicate with image capture device 110 and initiate control of motor 112 to capture multiple images across a wide field of view. Image capture device 110 may transmit the one or more images to processor circuit 120. Processor circuit 120 may analyze the captured images using an identification algorithm.

The identification algorithm may include a machine learning (ML) algorithm to identify the particular species of dangerous wildlife present within the captured images. The identification algorithm may include a generative AI algorithm. The identification algorithm may include a neural network for classifying captured images. The identification algorithm may include a generative artificial intelligence (AI) algorithm. Over time, the identification algorithm may communicate with processor circuit 120 to adjust the area of the image capture based on previous history or may adjust the area of image capture based upon temperature, season, or time of day, based on the temperature, season or time of day when dangerous wildlife was captured in the past. Captured images may be compared against images in database 150. Images in database 150 may include captured images, synthetic images, or a combination of captured images and synthetic images. Database 150 may include additional information on specific animal species, including but not limited to images, descriptions of behavior, common predators, and preferred repellent interventions. Information in database 150 may be updated by processor circuit 120 based on information received by transceiver 140.

In one of various examples, images in database 150 may include representative sample images of various venomous reptiles, including but not limited to snakes. Database 150 may include an image for one or more species common to a particular geographic area. In operation, the identification algorithm may calculate a match percentage for each of the images in database 150, the match percentage reflective of the likelihood that the captured image includes a reptile of the species represented in the image in database 150.

Processor circuit 120 may include a percentage threshold value. If the match percentage calculated by the identification algorithm exceeds the percentage threshold value, processor circuit 120 may determine that dangerous wildlife has been detected and generate an identification result, the identification result reflective of the type of animal detected.

Upon detection of dangerous wildlife, processor circuit 120 may communicate with repellent 130 to activate the repellent intervention. Processor circuit 120 may communicate additional information to repellent 130, the additional information including but not limited to coordinates indicative of the location of the dangerous wildlife, a positional angle of the repellent 130, a speed or a temperature for repellent 130. Additional information may include specific information based upon the specific dangerous wildlife identified. The additional information may include but is not limited to a wavelength, amplitude, frequency and time period for an audible sound alarm, and a pressure for a liquid or gaseous repellent.

Repellent 130 may include one or more interventions for repelling wildlife, including but not limited to a stream of water or other liquid, an audible alarm, dispersal of an olfactory agent, or generation of a seismic signal. The olfactory agent may be a chemical or biological compound with a predetermined smell. In one of various examples, repellent 130 may release an olfactory agent to introduce a smell reflective of the smell of a predator of the specific dangerous wildlife identified or of another natural repellent odor which may not necessarily be a predator of the identified wildlife. The olfactory agent may include, but is not limited to, peppermint oil, cayenne pepper, cloves, capsaicin, or predator fecal matter or urine. The olfactory agent may be a naturopathic or ayurvedic composition. The olfactory agent may also be a composition which may cause discomfort or irritation, but is not fatal to the identified dangerous wildlife. The olfactory agent may also be an attractive smell which may drive dangerous wildlife away by leading it away with a scent that the animal prefers. In one of various examples, repellent 130 may activate an audible alarm, the alarm including a sound reflective of the sounds produced by a predator of the specific dangerous wildlife identified. The audible alarm may be a human voice to scare away a dangerous animal. In one of various examples, repellent 130 may activate a source of light, the light source including but not limited to a coherent light source. The coherent light source may include a laser. In one of various examples, repellent 130 may activate a seismic response, including but not limited to a piston or plunger impacting the ground to produce a seismic response to scare away the dangerous wildlife.

Processor circuit 120 may select one of a plurality of repellent interventions, the selection based upon the identification result. In one of various examples, a different repellent intervention may be based on the animal species detected and behavioral analysis of the animal species detected.

Upon detection of dangerous wildlife, processor circuit 120 may send instructions to transceiver 140. Instructions sent to transceiver 140 may instruct transceiver 140 to transmit information based upon the specific wildlife species detected. Information transmitted may include the specific wildlife species detected, the level of danger, emergency protocols in case of a bite from the specific wildlife species detected, or other information specific to the wildlife species detected. Information transmitted by transceiver 140 may be transmitted to a mobile communication device. Information transmitted by transceiver 140 may include information on the protein sequence of the venom of the identified reptile which may inform the user of the appropriate anti-venom to use to counteract the effects of the venom.

Transceiver 140 may receive information from a mobile communication device or another Internet-enabled device. In one of various examples, transceiver 140 may receive information from a user based on the impact of the repellent intervention. In one of various examples, a user may observe that a specific repellent may be ineffective against a specific animal. This information may be communicated to processor circuit 120 via transceiver 140. This information may be used to update database 150 based on the effectiveness of the specific repellent intervention.

In this manner, dangerous wildlife may be identified and repelled from a particular location.

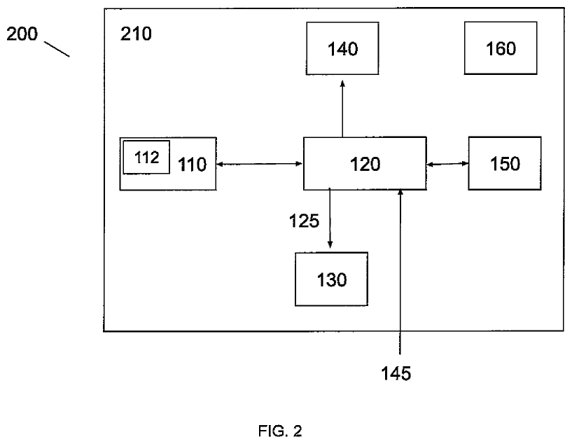

FIG. 2 illustrates one of various examples of a mobile system 200 for mitigating dangerous wildlife.

System 200 may include a vehicle 210. Vehicle 210 may be a wheeled vehicle or an airborne drone. Vehicle 210 may be an amphibious vehicle, including but not limited to an amphibious drone. Vehicle 210 may be an autonomous vehicle with independent control. Vehicle 210 may include Global Positioning System (GPS) circuitry. Transceiver 140 may transmit GPS information based on the location of the animal detected by system 200.

An image capture device 110 may capture images of an outdoor or indoor scene. Image capture device 110 may capture an underwater scene. A motor 112 may rotate image capture device 110 to capture multiple pictures in a wide angle. Motor 112 may enable image capture device 110 to capture multiple images in a 360-degree view.

Image capture device 110 may capture light in the visible spectrum between 400 nanometers and 700 nanometers of wavelength. Image capture device 110 may capture light in the infrared spectrum between 700 nanometers and 1000 nanometers of wavelength. Image capture device 110 may capture light from a spectrum outside both the visible spectrum and the infrared spectrum.

Image capture device 110 may be a radar transmitter and radar sensor to transmit radar waves and sense reflected radar waves to detect warm-blooded and cold-blooded animals during day or night. Image capture device 110 may be a sonar transmitter and sensor to transmit sonar waves and sense reflected sonar waves to detect warm-blooded and cold-blooded animals in bodies of water.

Image capture device 110 may be a thermal imaging camera to identify warm-blooded animals by sensing heat.

Image capture device 110 may be a Light Detection and Ranging (LIDAR) transmitter and sensor system capable to transmit laser light and to sense reflected laser light to detect cold-blooded and warm-blooded animals, in both night and day.

Image capture device 110 may be coupled to processor circuit 120. Image capture device 110 may be activated by a signal from processor circuit 120. Processor circuit 120 may receive an activation signal 145 from a user via a mobile app or remote control device. Processor circuit 120 may receive an activation signal 145 from an external device, including but not limited to a motion sensor or a timer. Processor circuit 120 may be a single hardware embodiment, or may be one or more processor circuits in a larger device. Processor circuit 120 may be comprised of a central processing unit (CPU) and one or more memory devices. Processor circuit 120 may include one or more bus interfaces to communicate with other devices. Processor circuit 120 may include other peripheral devices not shown in FIG. 2.

Processor circuit 120 may receive images from image capture device 110. Processor circuit 120 may process images received from image capture device 110 according to an identification algorithm. The identification algorithm may identify one or more features in the received images. The identification algorithm may identify one or more dangerous reptiles or animals in the received images. The identification algorithm may be a software program executing within processor circuit 120 or may be a dedicated hardware circuit within processor circuit 120.

During execution of the identification algorithm, processor circuit 120 may access information in database 150. Database 150 may include images of dangerous animals. Information accessed in database 150 may be used by the identification algorithm. Processor circuit 120 may produce an output 125 based upon the identification algorithm. Output 125 may be a single enable signal, or output 125 may be one or more encoded signals for communicating additional information based on the identification algorithm, the additional information including but not limited to coordinates indicative of the location of the dangerous wildlife, a positional angle of the repellent 130, a speed or a temperature for repellent 130. The additional information may include but is not limited to a wavelength, amplitude, frequency and time period for an audible sound alarm, and a pressure for a liquid or gaseous repellent.

Output 125 may be provided to repellent 130. Repellent 130 may include one or more interventions for repelling wildlife, including but not limited to a stream of water or other liquid, an audible alarm, dispersal of an olfactory agent, or generation of a seismic signal. The olfactory agent may be a chemical or biological compound with a predetermined smell.

Processor circuit 120 may communicate with transceiver 140. Processor circuit 120 may send instructions to transceiver 140 to instruct transceiver 140 to send information from the identification algorithm to a remote device.

Power supply 160 may provide power to other components in system 200. Power supply 160 may provide power to image capture device 110, motor 112, processor circuit 120, repellent 130 and database 150. Individual connections between power supply 160 and individual components are not shown to improve readability of the figure. Power supply 160 may include a rechargeable battery. Power supply 160 may include one or more solar panels to charge a rechargeable battery. Power supply 160 may include a wired connection to an alternating-current or direct-current power source. Power supply 160 may be a liquid hydrogen power source.

In operation, in one of various examples, a user may send activation signal 145 to processor circuit 120. Activation signal 145 may be sent via a mobile communication device over a communication network, or activation signal 145 may be sent via a physical switch or button over a wired connection. Upon receipt of the activation signal 145, processor circuit 120 may communicate with image capture device 110 and initiate capture of one or more images by image capture device 110. Processor circuit 120 may communicate with image capture device 110 and initiate control of motor 112 to capture multiple images across a wide field of view. Image capture device 110 may transmit the one or more images to processor circuit 120. Processor circuit 120 may analyze the captured images using an identification algorithm.

The identification algorithm may include a machine learning (ML) algorithm to identify the particular species of dangerous wildlife present within the captured images. The ML algorithm may include a neural network for classifying captured images. Captured images may be compared against images in database 150. The identification algorithm may include a machine learning (ML) algorithm to identify the particular species of dangerous wildlife present within the captured images. The identification algorithm may include a generative AI algorithm. The identification algorithm may include a neural network for classifying captured images. The identification algorithm may include a generative artificial intelligence (AI) algorithm. Over time, the identification algorithm may communicate with processor circuit 120 to adjust the area of the image capture based on previous history or may adjust the area of image capture based upon temperature, season, or time of day, based on the temperature, season or time of day when dangerous wildlife was captured in the past. Captured images may be compared against images in database 150. Images in database 150 may include captured images, synthetic images, or a combination of captured images and synthetic images. Database 150 may include additional information on specific animal species, including but not limited to images, descriptions of behavior, common predators, and preferred repellent interventions. Information in database 150 may be updated by processor circuit 120 based on information received by transceiver 140.

In one of various examples, images in database 150 may include representative sample images of various venomous reptiles, including but not limited to snakes. Database 150 may include an image for one or more species common to a particular geographic area. In operation, the identification algorithm may calculate a match percentage for each of the images in database 150, the match percentage reflective of the likelihood that the captured image includes a reptile of the species represented in the image in database 150.

Processor circuit 120 may include a percentage threshold value. If the match percentage calculated by the identification algorithm exceeds the percentage threshold value, processor circuit 120 may determine that dangerous wildlife has been detected. Upon detection of dangerous wildlife, processor circuit 120 may communicate with repellent 130 to activate the repellent mechanism. Processor circuit 120 may communicate additional information to repellent 130, the additional information including but not limited to coordinates indicative of the location of the dangerous wildlife, a positional angle of the repellent 130, a speed or a temperature for repellent 130. The additional information may include but is not limited to a wavelength, amplitude, frequency and time period for an audible sound alarm, and a pressure for a liquid or gaseous repellent. Additional information may include specific information based upon the specific dangerous wildlife identified. Repellent 130 may include one or more interventions for repelling wildlife, including but not limited to a stream of water or other liquid, an audible alarm, dispersal of an olfactory agent, or generation of a seismic signal. The olfactory agent may be a chemical or biological compound with a predetermined smell. In one of various examples, repellent 130 may release an olfactory agent to introduce a smell reflective of the smell of a predator of the specific dangerous wildlife identified. The olfactory agent may include, but is not limited to, peppermint oil, cayenne pepper, cloves, capsaicin, or predator fecal matter or urine. The olfactory agent may be a naturopathic or ayurvedic composition. The olfactory agent may also be a composition which may cause discomfort or irritation, but is not fatal to the identified dangerous wildlife. The olfactory agent may also be an attractive smell which may drive dangerous wildlife away by leading it away with a scent that the animal prefers. In one of various examples, repellent 130 may activate an audible alarm, the alarm including a sound reflective of the sounds produced by a predator of the specific dangerous wildlife identified. The audible alarm may be a human voice to scare away a dangerous animal. In one of various examples, repellent 130 may activate a source of light, the light source including but not limited to a coherent light source. The coherent light source may include a laser. In one of various examples, repellent 130 may activate a seismic response, including but not limited to a piston or plunger impacting the ground to produce a seismic response to scare away the dangerous wildlife.

Upon detection of dangerous wildlife, processor circuit 120 may send instructions to transceiver 140. Instructions sent to transceiver 140 may instruct transceiver 140 to transmit information based upon the specific wildlife species detected. Information transmitted may include the specific wildlife species detected, the level of danger, emergency protocols in case of a bite from the specific wildlife species detected, or other information specific to the wildlife species detected. Information transmitted by transceiver 140 may be transmitted to a mobile communication device.

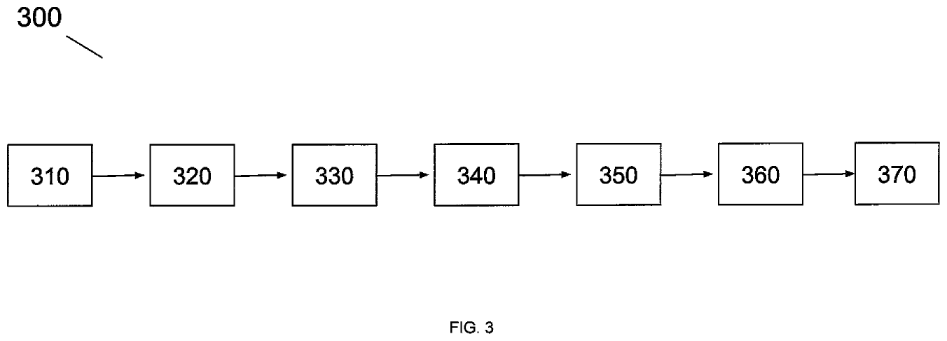

FIG. 3 illustrates a method 300 of mitigating dangerous wildlife.

At operation 310, an activation signal may be generated. The activation signal may be generated by a user via a mobile communication device or a remote control. The activation signal may be generated by a sensor based on motion, light, sound or another environmental input. The activation signal may be provided by a motion sensor, radar sensor, sonar sensor, LIDAR sensor or another sensor not specifically mentioned.

At operation 320, a processor circuit may be activated based on the activation signal.

At operation 330, the processor circuit may activate an image capture device, and the image capture device may capture one or more images.

At operation 340, the image capture device may transmit the one or more images to a processor circuit.

At operation 350, the processor circuit may execute an identification algorithm based upon the transmitted images, and based on the contents of a database, the database to include images and additional information. The additional information in the database may include information on specific animal species, including but not limited to images, descriptions of behavior, common predators, and preferred repellent interventions. The additional information may include a protein sequence of the venom. The database may include images representative of different species of reptiles. The identification algorithm may identify if any of the species of reptiles represented in the database of images are found in the captured images.

At operation 360, a repellent may be activated based upon the results of the identification algorithm. The repellent may include one or more interventions for repelling wildlife, including but not limited to a stream of water or other liquid, an audible alarm, transmission of light via visible light or a laser light source, dispersal of an olfactory agent, or generation of a seismic signal. The olfactory agent may be a chemical or biological compound with a predetermined smell. The olfactory agent may include, but is not limited to, peppermint oil, cayenne pepper, cloves, capsaicin, or predator fecal matter or urine. The olfactory agent may be a naturopathic or ayurvedic composition.

At operation 370, the processor circuit may transmit information based upon the results of the identification algorithm. Information transmitted may include the specific wildlife species detected, the level of danger, emergency protocols in case of a bite from the specific wildlife species detected, or other information specific to the wildlife species detected and the protein sequence of the venom of the wildlife species detected. Information transmitted may be transmitted to a mobile communication device. The mobile communication device may be a cellular phone handset, a tablet computer, a laptop computer or any other electronic device connected to a network. The processor circuit may receive information based on the effectiveness of the repellent intervention.

The present patent application relates to a processor circuit comprising multiple embodiments. The embodiments may include various configurations of hardware, software, or a combination thereof, that enable the processor circuit to perform different types of operations. In some embodiments, the processor circuit may be designed to execute specific types of algorithms or applications, such as signal processing, machine learning, image recognition or object detection and segmentation. Other embodiments may be optimized for power efficiency or for use in mobile devices. The processor circuit may also include different types of memory or storage components, such as cache memory, non-volatile memory, or random-access memory. Additionally, the processor circuit may be integrated with other electronic devices or components, such as sensors or communication interfaces, to enable a wide range of applications.

I claim:

1. A device comprising:
an image capture device;
a processor circuit to receive input from an activation signal and to receive images from the image capture device, the processor to identify features in the received images based on images stored in a database, the processor to generate an identification result;
a repellent to be enabled based at least upon the identification result, and
a transceiver to:
transmit information from the processor circuit to a mobile communication device, the information based at least on the identification result, and
receive information from the from a mobile communication device, the information based upon the effectiveness of the repellent.

2. The device as claimed in claim 1, the image capture device comprising a visible-light camera and a servo motor, the servo motor to rotate the visible-light camera.

3. The device as claimed in claim 1, the image capture device comprising a LIDAR transmitter and sensor and a servo motor, the servo motor to rotate the LIDAR transmitter and sensor.

4. The device as claimed in claim 1, the features comprising the presence of dangerous reptiles in one or more of the captured images.

5. The device as claimed in claim 1, the repellent comprising a water spray nozzle.

6. The device as claimed in claim 1, the repellent comprising an audio signal generated by the processor circuit, the audio signal driving a speaker.

7. The device as claimed in claim 1, the repellent comprising a seismic driver.

8. The device as claimed in claim 1, the repellent comprising a spray of a chemical compound.

9. A system comprising:
a vehicle;
an image capture device;
a processor circuit to receive input from an activation signal and to receive images from the image capture device, the processor to identify features in the received images based on images stored in a database, the processor to generate an identification result;
a repellent to be enabled based at least upon the identification result, and
a transceiver to:
transmit information from the processor circuit to a mobile communication device, the information based at least on the identification result, and
receive information from the from a mobile communication device, the information based upon the effectiveness of the repellent.

10. The system as claimed in claim 9, the image capture device comprising a visible-light camera and a servo motor, the servo motor to rotate the visible-light camera.

11. The system as claimed in claim 9, the image capture device comprising a LIDAR transmitter and sensor and a servo motor, the servo motor to rotate the LIDAR transmitter and sensor.

12. The system as claimed in claim 9, the features comprising the presence of dangerous animals in one or more of the captured images.

13. The system as claimed in claim 9, the repellent comprising a water spray nozzle.

14. The system as claimed in claim 9, the repellent comprising an audio signal and a speaker.

15. The system as claimed in claim 9, the repellent comprising a seismic driver.

16. The system as claimed in claim 9, the repellent comprising a spray of a chemical compound.

17. The system as claimed in claim 9, the vehicle comprising a wheeled vehicle.

18. The system as claimed in claim 9, the vehicle comprising an aerial drone.

19. A method comprising:
generating an activation signal,
activating a processor circuit based upon the activation signal,
capturing images,
transmitting the captured images to the processor circuit,
identifying a species of animal in the captured images to generate an identification result,
repelling the animal with a repellent intervention based on the identification result,
transmitting information based upon the identified species of animal, and
receiving information based on the effectiveness of repellent intervention.

20. The method as claimed in claim 19, the species of animal comprising one or more venomous animals.
